(19) United States
(12) Patent Application Publication
(10) Pub. No.: US 2019/0102839 A1
(43) Pub. Date: Apr. 4, 2019

(54) P2P INVESTMENT INTERMEDIATING MATCHING SYSTEM

(71) Applicants: Sinae KIM, Incheon (KR); Keonho KIM, Incheon (KR)

(72) Inventors: Sinae KIM, Incheon (KR); Keonho KIM, Incheon (KR)

(21) Appl. No.: 16/086,511

(22) PCT Filed: Aug. 14, 2017
(86) PCT No.: PCT/KR2017/008817

§ 371 Date: Sep. 19, 2018

(30) Foreign Application Priority Data
Aug. 24, 2016 (KR) 10-2016-0108019

(51) Int. Cl. G06Q 40/06; G06Q 40/04; G06Q 40/02; G06Q 30/06; G06Q 20/10; G06Q 20/06

(52) U.S. Cl. CPC G06Q 40/06; G06Q 40/04; G06Q 20/065; G06Q 30/06; G06Q 20/10; G06Q 40/025

(57) ABSTRACT

A peer-to-peer investment intermediating matching system issues a bond certificate in a form of a virtual currency with respect to an investment of an investor, and then matches investment conditions of investors and loan conditions of debtors to intermediate an investment therebetween, and, when an investment withdrawal and the like is required within an investment period, searches for and matches the investment conditions between the investors and then transfers bonds in a form of a bond transfer through a virtual currency, so as to enable the investment to be freely withdrawn.

### TECHNICAL FIELD

The present invention relates to a peer-to-peer (P2P) investment intermediating matching platform, and specifically, to a P2P investment intermediating matching platform 100 which includes investor terminals 120 respectively used by one or more investors 10, debtor terminals 130 respectively used by one or more debtors 20, and a peer-to-peer (P2P) investment intermediating matching platform server 110 connected to the respective investor terminals and debtor terminals through a communication network, wherein the P2P investment intermediating matching platform server 110 is configured to: receive investments (S1) to which investment conditions including at least one of an investment amount, a return on investment, and an investment period is added from the investor terminals 120; issue electronic currencies (S2) with respect to the investments to the investor terminals 120; receive loan applications (S3) to which loan conditions including at least one of a loan amount, an interest rate, and a loan period is added from the debtor terminals 130; and select an investment condition and a loan condition by matching the investment conditions and the loan conditions with each other, and then pay a loan (S4) to the debtor terminal 130 of the debtor 20 according to the selected investment condition and the loan condition.

### BACKGROUND ART

As is well known, a loan business of financial institutions such as a bank and a credit company holds an important position in modern society. Since most of profits in the financial institutions are created by the loan business, each financial institution is trying to efficiently perform the loan business. The loan business is a business that generates a predetermined economic power for a borrower secured on properties or credit of the borrower. Therefore, risk avoidance is the most important position, inter alia, and rapid processing for the loan business in the financial institution is more important than other things for the borrower.

Currently, a general credit review process conducted by the financial institution includes firstly inputting a resident registration number or corporation number repeatedly in contents of documents necessary upon an examination when examination documents are received, outputting input data on papers to be temporarily bound together, and then making six or seven copies to submit them to a decision-making organization by hand. Once decisions are made in the decision-making organization, the original documents are bound together and kept in a filing system.

When any subsequent change occurs, it is necessary to find the corresponding documents kept in the filing system, update the changed contents and again bind together the documents. Similarly, when completing the repayment, processes of finding the corresponding documents from the filing system, and dispersing the same should be executed. As for the loan business related to such an existing financial loan, there are a lot of existing inventions including a configuration disclosed in “an integrated management system for financial money borrowing/loan business (Korean Patent Registration No. 10-0956934)” of Patent Document 1 below.

However, in a case of such a typical loan, first, the financial institution manages the money received from a lender, and then loans it to the borrower. Therefore, most of risks that the loan cannot be recovered are shared by the financial institutions. Thus, to avoid any further risk, the financial institutions may operate the loan by increasing a difference between an interest paid by the borrower and an interest received by the lender. Therefore, the borrower has to pay more interest than necessary, and the lender is forced to earn lower interest income than the possible interest income.

On the other hand, unlike the existing financial loans described above, there is a financing method which is a type of investment intermediating method of intermediating so that a borrower (debtor) who needs funds can directly borrow the funds after attracting investors, and the borrower pays a commission of a predetermined amount. As existing inventions related to such an investment intermediating method, there are a lot of known inventions including “an

Internet-based investment intermediating server and an investment intermediating method thereof (Korean Patent Laid-open Publication No. 10-2001-0095986)” of Patent Document 2 below.

However, the existing investment intermediating methods described above are no more than a level of having characteristics that investment related information is merely processed through the Internet.

Meanwhile, the most important problem in the existing investment intermediating systems or methods described above are that, when an investor invests by setting a predetermined investment condition (in particular, an investment period), due to characteristics of the existing inventions that simply perform only the investment intermediating, a direct bond/debit relationship occurs between the investor and the debtor, and therefore, in principle, withdrawal of the investment principal is only possible after the investment period has elapsed. In other words, when the investor needs to withdraw the investment before an expiration of the investment period due to various circumstances, there is a problem that the investment cannot be withdrawn because the investor cannot force the repayment of the bond within the investment period set as the repayment period. In this case, depending on the circumstances of the investor, even if the investor is a creditor, the investor cannot repay his or her own debit and may go into bankruptcy.

In order to avoid the above-described problems, the investor may search a way of transferring his or her own investment bond to other investors, or the like. However, there is no adequate means for intermediating and matching appropriate other investors to transfer such a bond.

### SUMMARY OF INVENTION

### Problems to be Solved by Invention

In consideration of the above-mentioned circumstances, it is an object of the present invention to provide a peer-to-peer investment intermediating matching system which issues a bond certificate in a form of a virtual currency with respect to an investment of an investor, and then matches investment conditions of investors and loan conditions of debtors to intermediate an investment therebetween, and, when an investment withdrawal and the like is required within an investment period, searches for and matches the investment conditions between the investors and then transfers bonds in a form of a bond transfer through the virtual currency, so as to enable the investment to be freely withdrawn.

### Means for Solving Problems

To achieve the above-described object, according to an aspect of the present invention, there is provided a peer-to-peer (P2P) investment intermediating matching platform including: investor terminals 120 respectively used by one or more investors 10; debtor terminals 130 respectively used by one or more debtors; and a peer-to-peer (P2P) investment intermediating matching platform server 110 connected to the respective investor terminals and debtor terminals through a communication network, wherein the P2P investment intermediating matching platform server 110 is configured to: receive investments (S1) to which investment conditions including at least one of an investment amount, a return on investment, and an investment period is added from the investor terminals 120; issue electronic currencies (S2) with respect to the investments to the investor terminals 120; receive loan applications (S3) to which loan conditions including at least one of a loan amount, an interest rate, and a loan period is added from the debtor terminals 130, and select an investment condition and a loan condition by matching the investment conditions and the loan conditions with each other, and then pay a loan (S4) to the debtor terminal 130 of the debtor 20 according to the selected investment condition and the loan condition.

In addition, when transmitting an early-withdrawal request (S10) to the P2P investment intermediating matching platform server 110 by an investor terminal 120a of an early-withdrawal request investor 10a who wishes to withdraw the investment money before an expiration of the investment period among the investors 10, the P2P investment intermediating matching platform server 110 may perform bond transfer matching (S12) to select an investment condition by matching the investment conditions of other investors who have invested an investment, thereby selecting a bond transfer investor 10b based on the selected investment condition, and then may transfer the bond by transmitting the electronic currency (S15) from an investor terminal 120a of the early-withdrawal request investor 10a to an investor terminal 120b of the bond transfer investor 10b, and the P2P investment intermediating matching platform server 110 may pay the investment of the bond transfer investor 10b corresponding to the bond transfer as an early-withdrawal amount (S17) to the investor terminal 120a of the early-withdrawal request investor 10a.

Further, after performing the bond transfer matching (S12), the P2P investment intermediating matching platform server 110 may notify the investor terminal 120b of the selected bond transfer investor 10b of the early-withdrawal request (S13), and, when the transfer of the bond is accepted (S14) by the investor terminal 120b of the selected bond transfer investor 10b, may transfer the bond thereto (S15).

Further, after transferring the electronic currency according to the bond transfer (S15), the investor terminal 120b of the bond transfer investor 10b, the P2P investment intermediating matching platform server 110, and the investor terminal 120a of the early-withdrawal request investor 10a may verify the electronic currency according to blockchains (S16).

Further, when transferring the bond (S15), the P2P investment intermediating matching platform server 110 may notify the debtor terminal 130 of the debtor 20 of the bond transfer (S15a).

Further, the P2P investment intermediating matching platform server may pay a predetermined rate of an early-withdrawal interest to the investor terminal 120b of the bond transfer investor 10b from the investor terminal 120a of the early-withdrawal request investor 10a.

Meanwhile, when transmitting an early-redemption request (S20) to the P2P investment intermediating matching platform server 110 by a debtor terminal 130a of an early-redemption debtor 20a who wishes to early redeem the loan before the expiration of the loan period among the debtors 20, or when transmitting an early-withdrawal request (S21) to the P2P investment intermediating matching platform server 110 by the investor terminal 120a of the early-withdrawal request investor 10a who wishes to early withdraw the investment,

the P2P investment intermediating matching platform server 110 may perform early redemption matching (S22) which selects an early-redemption debtor and an early-withdrawal investor by matching the early-redemption requests and the early-withdrawal requests with each other, thus to select the early-redemption debtor and the early-withdrawal investor, may receive an early-redemption debt (S24) from the early-redemption debtor 20a by the debtor terminal 130a of the early-redemption debtor 20a, and then may pay the received debt as the early-withdrawal amount (S25) to the investor terminal 120a of the early-withdrawal request investor 10a.

Further, the investor terminal 120a of the early-withdrawal request investor 10a who has early withdrawn the investment may return the virtual currency corresponding to the early-withdrawal amount (S26) to the P2P investment intermediating matching platform server 110, and the P2P investment intermediating matching platform server 110 may transmit a bond extinguishment notification (S27) to the investor terminal 120a of the early-withdrawal request investor 10a, and may transmit a debt extinguishment notification (S28) to the debtor terminal 130a of the early-redemption debtor 20a.

Meanwhile, the P2P investment intermediating matching platform may further include: a credit rating agency server 150 connected to the P2P investment intermediating matching platform server 110 through a communication network, the P2P investment intermediating matching platform server 110 may use the loan condition by further including credit information of the debtor 20 received through the credit rating agency server 150.

In addition, the P2P investment intermediating matching platform may further include a financial institution server 140 connected to the P2P investment intermediating matching platform server 110 through a communication network, the P2P investment intermediating matching platform server 110 may use the loan condition by further including previous loan status information of the debtor 20 received through the financial institution server 140.

Meanwhile, the P2P investment intermediating matching platform server 110 may match one or more of the investors 10 and one or more of the debtors 20 by placing them into groups in any one form of one-to-one, one-to-many, many-to-one, and many-to-many depending on the investment conditions and the loan conditions, respectively.

Further, after receiving the loan applications (S3) to which the loan conditions including at least one of the loan amount, the interest rate, and the loan period is added from the debtor terminals 130, the P2P investment intermediating matching platform server 110 may transmit the received loan applications to the investor terminal 120 to notify as loan application information, and the investor terminal 120 of the investor 10 may transmit an investment with respect to the selected loan application among the loan application information to the P2P investment intermediating matching platform server 110.

Further, the P2P investment intermediating matching platform server 110 may preliminarily select investment conditions and loan conditions by matching them with each other, when the investment conditions and the loan conditions do not match each other, may preliminarily select investment conditions and loan conditions which are closest to each other, and may transmit and notify a fact of preliminary selection to the investor terminal 120 and the debtor terminal 130 of the investor and the debtor who present the investment condition and the loan condition corresponding to the preliminary selection, respectively.

### Advantageous Effects

According to the present invention, it is possible to issue a bond certificate in a form of a virtual currency with respect to an investment of an investor, and then match investment conditions of investors and loan conditions of debtors to intermediate an investment therebetween, and, when an investment withdrawal and the like is required within an investment period, search for and match the investment conditions between the investors and then transfer bonds in a form of a bond transfer through the virtual currency, so as to enable the investment to be freely withdrawn.

Meanwhile, the P2P investment intermediating matching system only deducts a predetermined commission from each investment transaction or bond transfer procedure, such that the investor may obtain a maximum return on an investment, and the debtor may borrow funds with a minimum interest on a loan.

### BRIEF DESCRIPTION OF DRAWINGS

FIG. 1 is a block diagram illustrating an entire configuration of a P2P investment intermediating matching system according to an embodiment of the present invention.

FIG. 2 is a diagram illustrating a basic operation of the P2P investment intermediating matching system according to the embodiment of the present invention.

FIG. 3 is a diagram illustrating an early withdrawal of investment by a bond transfer in the P2P investment intermediating matching system according to the embodiment of the present invention.

FIG. 4 is a diagram illustrating an early-redemption operation of the P2P investment intermediating matching system according to the embodiment of the present invention.

### MODE FOR CARRYING OUT INVENTION

Hereinafter, a peer-to-peer (P2P) investment intermediating matching system according to an embodiment of the present invention will be described in detail with reference to the accompanying drawings. First, it should be noted that, referring to the drawings, wherein like reference characters designate like or corresponding parts throughout the several views. In the description of the present invention, the publicly known functions and configurations that are judged to be able to make the purport of the present invention unnecessarily obscure will not be described.

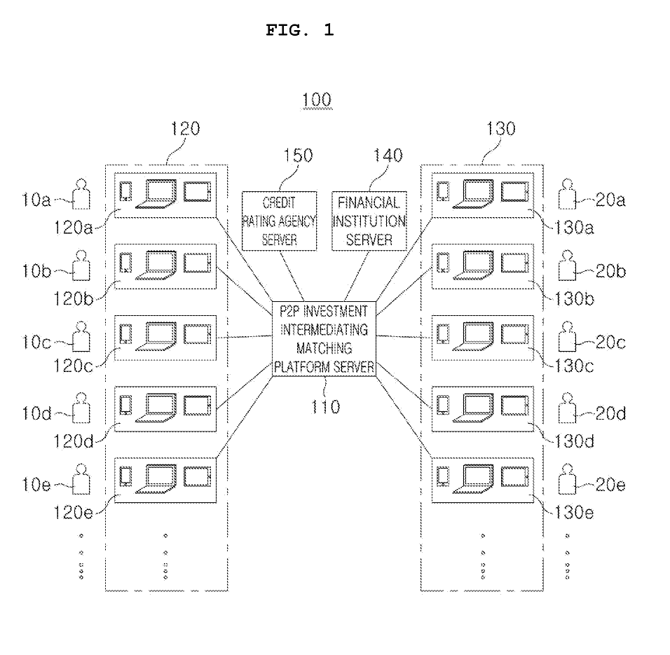

As illustrated in FIG. 1, a peer-to-peer (P2P) investment intermediating matching platform of the present invention generally includes investor terminals 120 respectively used by one or more investors 10, debtor terminals 130 respectively used by one or more debtors 20, and a peer-to-peer (P2P) investment intermediating matching platform server 110 connected to the respective investor terminals and debtor terminals through a communication network. In this disclosure, the ‘investor’ refers to a user who wishes to invest a predetermined amount of money using the P2P investment intermediating matching system according to the embodiment of the present invention, and the ‘debtor’ refers to a user who wishes to receive a loan using the P2P investment mediation matching system according to the embodiment of the present invention. Meanwhile, in the present invention, in consideration of a fact that one or more of the investors 10 may exist, when collectively referring to or there is no need to separately divide, the investors are presented by an “investor 10′ using reference numeral “10,” whereas when it is necessary to divide the investors (for example, when there is an investor who is a bond transfer or and an investor who is a bond transferee as in a case of a bond transfer described below), the investors are divisively presented by denoting lowercase alphabetical letters such as “10a”, “10b” and . . . in the reference numeral (these also apply to a case of the debtors in the same manner).

Meanwhile, the investor terminal 120 and the debtor terminal 130 include any one of means capable of being operated with a predetermined program installed therein, for example, a desktop computer, as well as a portable terminal such as a smart phone, a notebook, and a tablet PC used by the investor 10 or the debtor 20.

Generally, as illustrated in FIG. 1, the P2P investment intermediating matching platform of the present invention is preferably further connected to at least one of a financial institution server 140 and a credit rating agency server 150 through a communication network.

Hereinafter, an operation of a P2P investment intermediating matching system according to an embodiment of the present invention will be described.

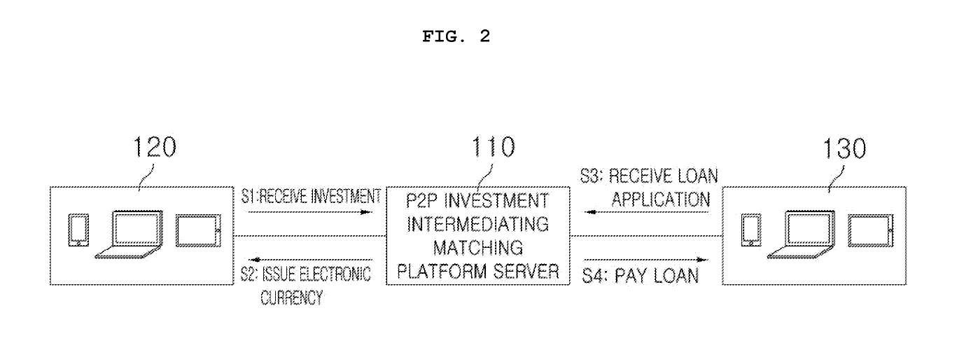

First, a basic investment-loan matching operation will be described. In this case, as illustrated in FIG. 2, the P2P investment intermediating matching platform server 110 receives investments (S1) to which investment conditions including at least one of an investment amount, a return on investment, and an investment period is added from the investor terminals 120, and issues electronic currencies (S2) with respect to the investments to the investor terminals 120. In this case, the electronic currency has a function of a kind of bond certificate, and has an important function that enables a free and easy bond transfer as described below. Meanwhile, the P2P investment intermediating matching platform server 110 receives loan applications (S3) to which loan conditions including at least one of a loan amount, an interest rate, and a loan period is added from the debtor terminals 130. Thereafter, the P2P investment intermediating matching platform server 110 selects an investment condition and a loan condition by matching the investment conditions and the loan conditions with each other, and then pays a loan (S4) to the debtor terminal 130 of the debtor 20 according to the selected investment condition and the loan condition.

In this case, for the operation of selecting the investment condition and the loan condition by matching them with each other, most basically, it is preferable to select a case in which the investment conditions presented by several investors and the loan conditions presented by several debtors are shared with each other (for example, by matching an investor and a debtor whose investment condition and loan condition coincide with each other). Meanwhile, there may be a case in which the investment condition and the loan condition are set to a predetermined range (for example, a return on investment of 8 to 12% per year) rather than a case in which the investor designates one fixed value (for example, a return on investment of 10% per year). Accordingly, in this case, for the operation of selecting the investment condition and the loan condition by matching them with each other, it is also preferable to select a case in which the investment conditions presented by several investors and the loan conditions presented by several debtors are shared with each other (for example, when a return on investment designated by an investor is 8 to 12% per year, and a loan rate applied for by the debtor is 7 to 9% per year, the return on investment and the loan rate are duplicated in a range of 8 to 9% per year, which will be selected to be regarded as they are shared with each other by matching).

On the other hand, there may be a case in which the investment conditions and the loan conditions respectively presented by the investors or the debtors do not match each other, as described above. In this case, the P2P investment intermediating matching platform server 110 preliminarily selects investment conditions and loan conditions which are closest to each other (for example, when an investor presents a return on investment of 8 to 12% per year, if debtors a, b and c present loan rates of 4 to 5% per year, 5 to 6% per year and 6 to 7% per year, respectively, the debtor c who presents the loan rate of 6 to 7% per year which is closest to the return on investment of 8 to 12% per year presented by the investor is preliminarily selected).

Meanwhile, in the case of such a preliminary selection, since the investor and the debtor are not matched or shared with each other in terms of the investment condition and loan condition desired by each of them, it is not preferable to automatically perform the investment intermediating matching. Accordingly, in order to notify the investor and the debtor that they have been preliminary selected, and allow them to change or adjust the investment condition and the loan condition with each other, it is preferable that the P2P investment intermediating matching platform server 110 transmits and notifies the fact of preliminary selection to the investor terminal 120 and the debtor terminal 130 of the investor and the debtor who present the investment condition and the loan condition corresponding to the preliminary selection, respectively.

In addition, when the P2P investment intermediating matching platform server 110 is further connected to the credit rating agency server 150 through the communication network, the P2P investment intermediating matching platform server 110 preferably uses the loan condition by further including credit information of the debtor 20 received through the credit rating agency server 150.

Furthermore, when the P2P investment intermediating matching platform server 110 is further connected to the financial institution server 140 through the communication network, the P2P investment intermediating matching platform server 110 preferably uses the loan condition by further including previous loan status information of the debtor 20 received through the financial institution server 140.

Meanwhile, it is possible that the P2P investment intermediating matching platform server 110 matches one or more of the investors 10 and one or more of the debtors 20 by placing them into groups in any one form of one-to-one, one-to-many, many-to-one, and many-to-many depending on the investment conditions and the loan conditions, respectively. That is, it is also possible to perform the investment intermediating matching by placing a plurality of investors having similar investment conditions into one group, or placing a plurality of debtors having similar loan conditions into one group.

In addition, in order to allow the investors to have an enlarged selection width of various loan applications, after receiving the loan applications (S3) to which the loan conditions including at least one of the loan amount, the interest rate, and the loan period is added from the debtor terminals 130, it is preferable that the P2P investment intermediating matching platform server 110 transmits the received loan applications to the investor terminal 120 to notify the investor as loan application information, and the investor terminal 120 of the investor 10 transmits an investment with respect to the selected loan application among the loan application information to the P2P investment intermediating matching platform server 110.

Meanwhile, financial transactions such as the investment or the payment of the loan may be made through the Internet remittance or the like, which is performed in the P2P investment intermediating matching platform server 110, the investor terminal 120, and the debtor terminal 130, and it is also possible to pay the loan through various types of electronic currencies as necessary.

Next, an early-withdrawal operation of the investment by a bond transfer of the investor will be described.

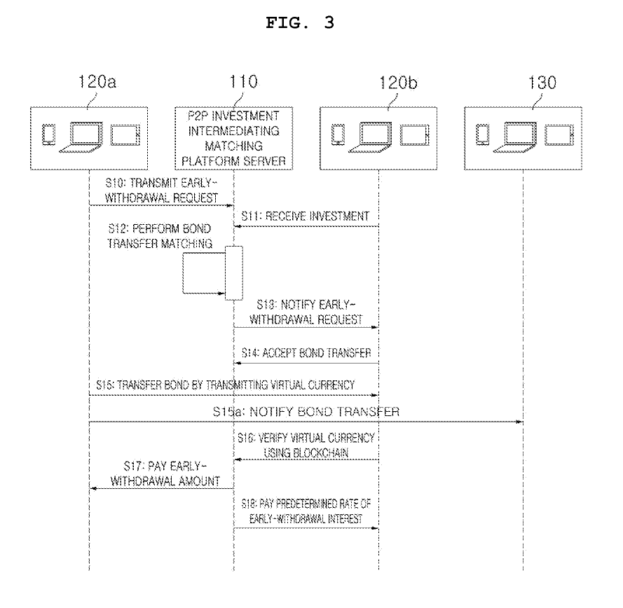

If there is an early-withdrawal request investor 10a who wishes to withdraw the investment before an expiration of the investment period among the investors 10, as illustrated in FIG. 3, the investor terminal 120a of the early-withdrawal request investor 10a may transmit an early-withdrawal request (S10) to the P2P investment intermediating matching platform server 110.

In this case, the P2P investment intermediating matching platform server 110 performs bond transfer matching (S12) to select an investment condition by matching the investment conditions of other investors who have invested an investment, thereby selecting a bond transfer investor 10b based on the selected investment condition. Such bond transfer matching (S12) has the similar operation method to the investment mediation matching described above, except that the matching is performed between the investment conditions, not between the investment conditions and the loan conditions. Once the bond transfer investor 10b is selected, as illustrated in FIG. 3, the P2P investment intermediating matching platform server 110 transfers the bond by transmitting the electronic currency (S15) from an investor terminal 120a of the early-withdrawal request investor 10a to an investor terminal 120b of the bond transfer investor 10b, and pays the investment of the bond transfer investor 10b corresponding to the bond transfer as an early-withdrawal amount (S17) to the investor terminal 120a of the early-withdrawal request investor 10a. Through processes, when an investor has to withdraw the investment before the expiration of the investment period due to various circumstances, the above-described problem that the investment cannot be withdrawn because the investor cannot force the repayment of the bond within the investment period set as the repayment period may be solved, and thereby it is possible to freely withdraw the investment through the bond transfer by the transmittance of the electronic currency according to the matching between the investors.

Meanwhile, it is preferable that, after performing the bond transfer matching (S12), the P2P investment intermediating matching platform server 110 notifies the investor terminal 120b of the selected bond transfer investor 10b of the early-withdrawal request (S13), and, when the transfer of the bond is accepted (S14) by the investor terminal 120b of the selected bond transfer investor 10b, transfers the bond thereto (S15). That is, it is preferable to allow the selected bond transfer investor 10b so as to select whether a bond transfer procedure is performed through his or her own investor terminal 120b.

In addition, after transferring the electronic currency according to the bond transfer (S15), the investor terminal 120b of the bond transfer investor 10b, the P2P investment intermediating matching platform server 110, and the investor terminal 120a of the early-withdrawal request investor 10a may verify the electronic currency according to blockchains (S16). The blockchain is a verification system or a method capable of verifying whether the electronic currency or virtual currency is falsified or the transaction has truth in the circulation of the electronic currency or the virtual currency, and is the same technique as a type of decentralized public ledger in which all transactions occurred within a unit of time are bundled into blocks, and the blocks are connected with each other like one chain according to a chronological order to share them on an entire network, thereby, only the blocks recognized by an agreement (a proof of work (PoW)) of more than half of anonymous nodes (minors) are officially recorded on the ledger. The technique related to the blockchain is a technique of a level that is widely used in fields of virtual currency or electronic currency, and therefore will not be described in detail.

Meanwhile, in order to automatically perform notification of a debtor, which is a legal requirement for the bond transfer, when transferring the bond (S15) as illustrated in FIG. 3, it is preferable that the P2P investment intermediating matching platform server 110 notifies the debtor terminal 130 of the debtor 20 of the bond transfer (S15a).

In addition, the early-withdrawal request investor 10a may pay a predetermined rate of an interest to the bond transfer investor 10b in return for the early withdrawal of his or her investment according to the early withdrawal, such that the bond transfer and the bond reception may be promoted. For this purpose, as illustrated in FIG. 3, it is preferable that the P2P investment intermediating matching platform server pays a predetermined rate of an early-withdrawal interest (S18) to the investor terminal 120b of the bond transfer investor 10b from the investor terminal 120a of the early-withdrawal request investor 10a.

The above-described early withdrawal of the bond can be performed not only for the entire amount of the investment but also for a part of the investment in a form of partial early withdrawal. In this case, only the portion of the investment desired to be early withdrawn under the investment condition is changed to a part of the investment that is desired to be early withdrawn but is not the entire amount of the investment. Thereby, it is possible to separately perform the transfer only for the partial early-withdrawal amount in a form of partial transfer of the bond in the bond transfer, or the like through the virtual currency.

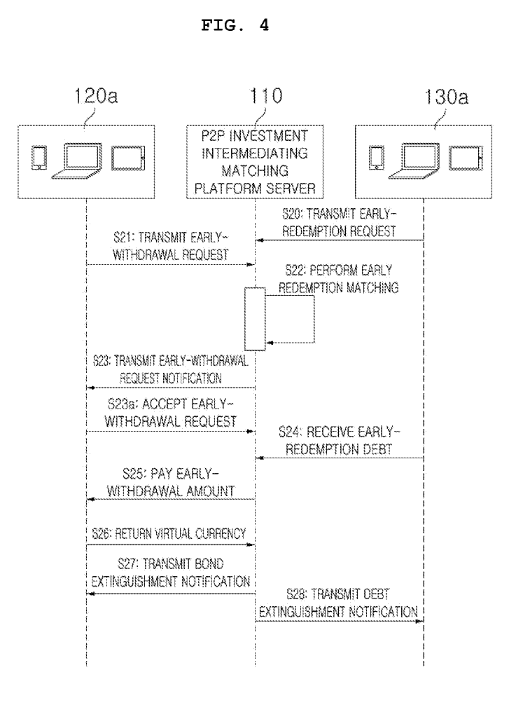

Meanwhile, in response to an investor's desire for an early withdrawal, a debtor may want to perform early redemption depending on his or her desired situation. For such a case, the P2P investment intermediating matching platform 100 according to the embodiment of the present invention is preferably configured to be capable of performing an early-redemption operation as illustrated in FIG. 4.

That is, when transmitting an early-redemption request (S20) to the P2P investment intermediating matching platform server 110 by a debtor terminal 130a of an early-redemption debtor 20a who wishes to early redeem the loan before the expiration of the loan period among the debtors 20, or when transmitting an early-withdrawal request (S21) to the P2P investment intermediating matching platform server 110 by the investor terminal 120a of the early-withdrawal request investor 10a who wishes to early withdraw the investment, as illustrated in FIG. 4, the P2P investment intermediating matching platform server 110 performs early redemption matching (S22) which selects an early-redemption debtor and an early-withdrawal investor by matching the early-redemption requests and the early-withdrawal requests with each other, thus to select the early-redemption debtor and the early-withdrawal investor. The early redemption matching (S22) process which selects an early-redemption debtor and an early-withdrawal investor by matching the early-redemption requests and the early-withdrawal requests with each other also has the similar operation method to the investment mediation matching method described above in terms of matching the loan conditions changed in the loan period with each other and matching the investment conditions changed in the investment period with each other.

Thereafter, the P2P investment intermediating matching platform server receives an early-redemption debt (S24) from the early-redemption debtor 20a by the debtor terminal 130a of the early-redemption debtor 20a, and then pays the received debt as the early-withdrawal amount (S25) to the investor terminal 120a of the early-withdrawal request investor 10a, such that the early redemption becomes possible.

In this case, considering an aspect that the investment is achieved through the virtual currency, it is preferable that the investor terminal 120a of the early-withdrawal request investor 10a who has early withdrawn the investment returns the virtual currency corresponding to the early-withdrawal amount to the P2P investment intermediating matching platform server 110 as illustrated in FIG. 4 (S26). In addition, it is preferable that the P2P investment intermediating matching platform server 110 transmits a bond extinguishment notification (S27) to the investor terminal 120a of the early-withdrawal request investor 10a, and transmits a debt extinguishment notification (S28) to the debtor terminal 130a of the early-redemption debtor 20a.

Meanwhile, in order to provide an opportunity of selection once more to the early-withdrawal investor selected by the above-described early repayment matching

(S22), the P2P investment intermediating matching platform server 110 transmits an early-withdrawal request notification (S23) to the investor terminal 120a of the early-withdrawal request investor 10a, and the investor terminal 120a of the early-withdrawal request investor 10a transmits whether the early-withdrawal request is accepted (S23a) to the P2P investment intermediating matching platform server 110.

As described above, optimal embodiments have been disclosed in the drawings and the specification. Although specific terms have been used herein, these are only intended to describe the present invention and are not intended to limit the meanings of the terms or to restrict the scope of the present invention as disclosed in the accompanying claims. Accordingly, those skilled in the art will appreciate that various modifications and other equivalent embodiments are possible from the above embodiments. Therefore, the scope of the present invention should be defined by the technical spirit of the accompanying claims.

1. A peer-to-peer (P2P) investment intermediating matching platform comprising:
investor terminals respectively used by one or more investors; debtor terminals respectively used by one or more debtors; and a peer-to-peer (P2P) investment intermediating matching platform server connected to the respective investor terminals and debtor terminals through a communication network,
wherein the P2P investment intermediating matching platform server is configured to:
receive investments to which investment conditions including at least one of an investment amount, a return on investment, and an investment period is added from the investor terminals,
issue electronic currencies with respect to the investments to the investor terminals;
receive loan applications to which loan conditions including at least one of a loan amount, an interest rate, and a loan period is added from the debtor terminals, and
select an investment condition and a loan condition by matching the investment conditions and the loan conditions with each other, and then pay a loan to the debtor terminal of the debtor according to the selected investment condition and the loan condition.

2. The P2P investment intermediating matching platform according to claim 1, wherein, when transmitting an early-withdrawal request to the P2P investment intermediating matching platform server by an investor terminal of an early-withdrawal request investor who wishes to withdraw the investment money before an expiration of the investment period among the investors;
the P2P investment intermediating matching platform server performs bond transfer matching to select an investment condition by matching the investment conditions of other investors who have invested an investment, thereby selecting a bond transfer investor based on the selected investment condition, and then transfers the bond by transmitting the electronic currency from an investor terminal of the early-withdrawal request investor to an investor terminal of the bond transfer investor; and
the P2P investment intermediating matching platform server pays the investment of the bond transfer investor corresponding to the bond transfer as an early-withdrawal amount to the investor terminal of the early-withdrawal request investor.

3. The P2P investment intermediating matching platform according to claim 2, wherein, after performing the bond transfer matching, the P2P investment intermediating matching platform server notifies the investor terminal of the selected bond transfer investor of the early-withdrawal request; and
when the transfer of the bond is accepted by the investor terminal of the selected bond transfer investor, transfers the bond thereto.

4. The P2P investment intermediating matching platform according to claim 3, wherein, after transferring the electronic currency according to the bond transfer, the investor terminal of the bond transfer investor, the P2P investment intermediating matching platform server, and the investor terminal of the early-withdrawal request investor verify the electronic currency according to blockchains.

5. The P2P investment intermediating matching platform according to claim 4, wherein, when transferring the bond, the P2P investment intermediating matching platform server notifies the debtor terminal of the debtor of the bond transfer.

6. The P2P investment intermediating matching platform according to claim 5, wherein the P2P investment intermediating matching platform server pays a predetermined rate of an early-withdrawal interest to the investor terminal of the bond transfer investor from the investor terminal of the early-withdrawal request investor.

7. The P2P investment intermediating matching platform according to claim 1, wherein, when transmitting an early-redemption request to the P2P investment intermediating matching platform server by a debtor terminal of an early-redemption debtor who wishes to early redeem the loan before the expiration of the loan period among the debtors, or when transmitting an early-withdrawal request to the P2P investment intermediating matching platform server by the investor terminal of the early-withdrawal request investor who wishes to early withdraw the investment,
2P investment intermediating matching platform server 110 performs early redemption matching which selects an early-redemption debtor and an early-withdrawal investor by matching the early-redemption requests and the early-withdrawal requests with each other, thus to select the early-redemption debtor and the early-withdrawal investor, receives an early-redemption debt from the early-redemption debtor by the debtor terminal of the early-redemption debtor, and then pays the received debt as the early-withdrawal amount to the investor terminal of the early-withdrawal request investor.

8. The P2P investment intermediating matching platform according to claim 7, wherein the investor terminal of the early-withdrawal request investor who has early withdrawn the investment returns the virtual currency corresponding to the early-withdrawal amount to the P2P investment intermediating matching platform server; and
the P2P investment intermediating matching platform server transmits a bond extinguishment notification to the investor terminal of the early-withdrawal request investor, and transmits a debt extinguishment notification to the debtor terminal of the early-redemption debtor.

9. The P2P investment intermediating matching platform according to claim 1, further comprising:
a credit rating agency server connected to the P2P investment intermediating matching platform server through a communication network,
wherein the P2P investment intermediating matching platform server uses the loan condition by further including credit information of the debtor 20 received through the credit rating agency server.

10. The P2P investment intermediating matching platform 100 according to claim 1, further comprising:
a financial institution server connected to the P2P investment intermediating matching platform server through a communication network,
wherein the P2P investment intermediating matching platform server uses the loan condition by further including previous loan status information of the debtor received through the financial institution server.

11. The P2P investment intermediating matching platform according to claim 1, wherein the P2P investment intermediating matching platform server matches one or more of the investors and one or more of the debtors by placing them into groups in any one form of one-to-one, one-to-many, many-to-one, and many-to-many depending on the investment conditions and the loan conditions, respectively.

12. The P2P investment intermediating matching platform according to claim 1, wherein, after receiving the loan applications to which the loan conditions including at least one of the loan amount, the interest rate, and the loan period is added from the debtor terminals, the P2P investment intermediating matching platform server transmits the received loan applications to the investor terminal to notify as loan application information; and
the investor terminal of the investor transmits an investment with respect to the selected loan application among the loan application information to the P2P investment intermediating matching platform server.

13. The P2P investment intermediating matching platform according to claim 1, wherein the P2P investment intermediating matching platform server preliminarily selects investment conditions and loan conditions by matching them with each other
when the investment conditions and the loan conditions do not match each other, preliminarily selects investment conditions and loan conditions which are closest to each other, and
transmits and notifies a fact of preliminary selection to the investor terminal and the debtor terminal of the investor and the debtor who present the investment condition and the loan condition corresponding to the preliminary selection, respectively.
